(19) United States
(12) Patent Application Publication
(10) Pub. No.: US 2025/0224044 A1
(43) Pub. Date: Jul. 10, 2025

(54) HEIGHT-ADJUSTABLE VALVE FOR CONTINUOUS WATER SUPPLY

(71) Applicant: Jae Hyun KIM, Seoul (KR)

(72) Inventor: Jae Hyun KIM, Seoul (KR)

(21) Appl. No.: 19/012,755

(22) Filed: Jan. 7, 2025

Related U.S. Application Data
(63) Continuation of application No. PCT/KR2023/011728, filed on Aug. 9, 2023.

(30) Foreign Application Priority Data
Aug. 25, 2022 (KR) 10-2022-0106776

(51) Int. Cl. F16K 27/02; F16K 3/02

(52) U.S. Cl. CPC F16K 27/0209; F16K 3/0227

(57) ABSTRACT

Provided is a height-adjustable valve for continuous water supply. Specifically, provided is a valve for continuous water supply, structured such that a bonnet for containing a valve disc has a reduced height. Conventionally, when installing a valve for continuous water supply, if the tubular depth is close to the ground, a part of the structure protrudes out of the ground, and the structure needs to be slanted and installed. In order to overcome such an inconvenience, the height of the bonnet for containing a valve disc is improved by making same lower than in conventional cases, thereby providing the height-adjustable valve for continuous water supply.

### TECHNICAL FIELD

The present invention relates to a height-adjustable valve for continuous water supply.

More specifically, the present invention relates to a valve for continuous water supply having a structure capable of adjusting the height of a bonnet configured to accommodate a valve disc therein. In the related art, during construction of the valve for continuous water supply, when the depth of a pipe is close to the ground, a partial structure of the valve protrudes outwards from the ground. In this case, the valve needs to be installed in the ground in a state of being inclined. In order to address such an inconvenience, the present invention provides a height-adjustable valve for continuous water supply capable of further lowering the height of a bonnet configured to accommodate a valve disc therein as compared with a bonnet of the related art.

### BACKGROUND ART

In general, water control valves are installed every 1 to 3 kilometers on a water supply pipe. When a part of the water supply pipe is replaced with a new water supply pipe, it is required to close the water control valves respectively installed on the front side and the rear side of the water supply pipe to be replaced, thereby blocking the flow of water.

Meanwhile, even though only a part of the water supply pipe is replaced with a new one, it is required to close the water control valves respectively located in front of and behind the water supply to be replaced and disposed apart from each other with a long distance therebetween. As a result, water does not flow to many household water supply pipes branching from the partial water supply pipe located between the above-described water control valves, leading to water shortages in households, also known as water scarcity. Ultimately, such water shortage causes a variety of inconveniences to residents, agricultural crops, and other business fields.

In addition, when the water control valve is worn out, a valve shut-off function of the water control valve may not be properly performed, and other functions thereof may not be properly performed. Accordingly, water shortage may easily occur, and it may take a long time for replacement work of the water supply pipe. As a result, many residents may undergo inconveniences caused by increasing water shortage.

In order to address the above-described problems, there is known a method of replacing a pipe such as a water supply pipe with a new pipe using a valve for continuous water supply.

An example of the method using the valve for continuous water supply will be described with reference to FIGS. 4 and 5.

First, a valve body 110, which is a component of the valve for continuous water supply, is mounted on the outer diameter of a water supply pipe 100 to be replaced. The valve body 110 is formed of a pair of hemispherical bodies capable of wrapping around the outer diameter of the water supply pipe. In particular, an opening 114 is formed in the upper surface of an upper hemispherical body 112, and an auxiliary valve 116 capable of opening and closing the opening is installed inside the upper hemispherical body.

Subsequently, rotation devices (not shown) capable of rotating the valve body 110 are respectively mounted on the front side and the rear side of the valve body 110 of the water supply pipe 100. Thereafter, a perforation device (not shown) is mounted on the opening 114 of the upper hemispherical body 112 of the valve body 110 so as to maintain watertightness between the perforation device and the opening.

In this case, the auxiliary valve 116 provided in the upper hemispherical body 112 is operated in the opened state so as to allow an end mill cutter of the perforation device to be in close contact with the outer diameter surface of the water supply pipe 100.

Next, when the valve body 110 is rotated in the arc direction of the water supply pipe 100 using the rotation devices, the perforation device assembled with the upper hemispherical body 112 of the valve body 110 is also rotated at the same angle.

Accordingly, when the perforation device is rotated at the same angle, the end mill cutter of the perforation device is operated to process a perforation hole 102 in the outer diameter surface of the water supply pipe 100, thereby forming the arc-shaped perforation hole 102 in the outer diameter surface of the water supply pipe 100.

Then, in order to prevent water leakage through the perforation hole 102 of the water supply pipe 100, the auxiliary valve 116 provided in the upper hemispherical body 112 is operated to enter the closed state thereof. Thereafter, the perforation device is removed.

Next, a bonnet 130 including a valve disc 400, built therein and configured to be vertically moved, is assembled with the opening 114 of the upper hemispherical body 112 of the valve body 110 so as to maintain watertightness therebetween. Then, the auxiliary valve is operated to enter the opened state thereof again.

Subsequently, the valve disc 400 screwed to the stem inside the bonnet 130 is moved downwards by rotating a stem 132 exposed to the upper portion of the bonnet 130. In this case, the valve disc 400 is moved downwards until the same passes through the perforation hole 102 perforated in the outer surface of the water supply pipe 100 and is completely inserted into the water supply pipe 100.

Finally, auxiliary parts such as the rotation devices are removed from the valve body of the water supply pipe, and the assembly process of the valve for continuous water supply is completed. Thereafter, replacement work for the water supply pipe is started.

In this case, a rubber valve seat forming the outer body of the valve disc is in close contact with the inner diameter surface of the water supply pipe, thereby making it possible to block the flow of water.

However, in the above-described valve for continuous water supply, when the depth of the pipe is close to the ground, the valve for continuous water supply protrudes outwards from the ground during construction thereof. In this case, the valve for continuous water supply needs to be inclined during construction thereof, which causes inconvenience in construction.

In the case of a conventional valve for continuous water supply, an auxiliary valve is built into an upper plate so as to perform construction using a perforator and maintenance of a valve disc, and the valve disc is located above the auxiliary valve. In consideration of limitation of such a mechanical structure, there is a limit to reducing the height of the valve for continuous water supply and as such, the above-described problem occurs when the height of the pipe is close to the ground.

Therefore, in order to address the above-described problems, the applicant devised a valve for continuous water supply including a bonnet configured to accommodate a valve disc therein with an improved structure.

### DISCLOSURE

### Technical Problem

Therefore, the present invention has been made in view of the above problems, and it is an object of the present invention to provide a structure capable of lowering the height of a valve for continuous water supply. In the related art, during construction of the valve for continuous water supply, when the depth of a pipe is close to the ground, a partial structure of the valve protrudes outwards from the ground. In this case, the valve needs to be installed in the ground in a state of being inclined. In order to address such an inconvenience, the present invention provides a height-adjustable valve for continuous water supply capable of further lowering the height of a bonnet configured to accommodate a valve disc therein as compared with a bonnet of the related art.

### Technical Solution

In accordance with the present invention, the above and other objects can be accomplished by the provision of a height-adjustable valve for continuous water supply, the height-adjustable valve including a bonnet structure having an adjustable height, wherein the height of the bonnet structure is lowered by pressing force applied to the bonnet structure at a construction site, and the bonnet structure maintains the lowered height thereof.

The bonnet structure may maintain the lowered height thereof by pressing a low-height insert body (30) into the bonnet structure and coupling a fixing cover (70) to the bonnet structure at the construction site.

The bonnet structure may include
a valve disc (10),
a bonnet (20) configured to accommodate the valve disc (10) therein, the bonnet being coupled to a housing so as to withdraw the valve disc (10),
the low-height insert body (30) inserted into an upper side of the bonnet (20), the low-height insert body being configured to adjust a height of the bonnet,
an intermediate cover (40) configured to cover the upper side of the bonnet (20) having the low-height insert body (30) inserted thereinto, the intermediate cover having a hole formed in one side thereof, the hole having a predetermined diameter,
a stem cover (60) inserted into and seated in the low-height insert body (30),
a stem (50) coupled to one side of the stem cover (60), the stem penetrating the intermediate cover (40), the low-height insert body (30), and the bonnet (20) in a downward direction so as to be coupled to the valve disc (10), and
the fixing cover (70) coupled to an upper side of the intermediate cover (40) and configured to cover a lower portion of the stem cover (60), the fixing cover having a hole formed in one side thereof, the hole being configured for one end of the stem to be exposed therethrough.

The low-height insert body (30) may have
a lower end formed to be bent and expanded,
the low-height insert body (30) may include a through hole (32) formed to penetrate an inner side thereof in a height direction of the low-height insert body (30), and
the low-height insert body (30) may have a concave seating groove (31) formed in one side of an upper surface thereof.

one side of an upper surface of the bonnet (20)
may be formed to be expanded in a circular shape, and
the upper surface may have a hole (21) formed in the other side thereof, the hole being formed to have a diameter corresponding to an expanded area of the low-height insert body (30).

The bonnet (20) may further include
a seating part (22) provided in the hole (21) of the bonnet (20), the seating part

being configured for the low-height insert body (30) to be seated thereon in a state of being inserted into the hole, and
the seating part (22) may include
a semicircular plate configured to, when the stem (50) penetrating the low-height insert body (30) is further moved in the downward direction so as to be coupled to the valve disc (10), prevent interference with movement of the valve disc (10), and a side wall is erected from the semicircular plate and is integrally coupled to an inner side of the expanded upper surface of the bonnet (20).

The intermediate cover (40) may include a through hole formed in one side thereof, and
the through hole of the intermediate cover (40) may have a diameter corresponding to an unexpanded diameter of the low-height insert body (30).

An O-ring may be located between the through hole of the intermediate cover (40) and the low-height insert body (30).

In the above-described bonnet structure,
when the intermediate cover (40) is coupled to the bonnet (20), the expanded end of the low-height insert body (30) may be located in the hole (21) of the bonnet (20) in a state in which the low-height insert body is fixed by the intermediate cover (40),
and then, the low-height insert (30) is pressed downwards so as to be inserted into the bonnet at the construction site,
thereby preventing the end of the stem from being exposed to an upper side of the ground during construction.

The bonnet (20) may be formed of a height adjustment bonnet (201) disposed at an upper portion of the bonnet and a fixed bonnet (202) disposed at a lower portion thereof so as to adjust a height of the bonnet in a form of an antenna, and
the height adjustment bonnet (201) may be inserted into the fixed bonnet (202) so as to adjust the height of the bonnet.

The height-adjustable valve may further include a bolt fixing structure configured to, after the height adjustment bonnet (201) is inserted into the fixed bonnet (202), fix the height adjustment bonnet to the fixed bonnet using a bolt.

The fixed bonnet (202) may have a plurality of sealing means provided on one side thereof, the sealing means being configured to seal a space between the fixed bonnet and the height adjustment bonnet (201).

The fixed bonnet (202) may have any one shape selected from a square, a cylinder, and a polygon.

### Advantageous effects

In the related art, during construction of a valve for continuous water supply, when the depth of a pipe is close to the ground, a partial structure of the valve protrudes outwards from the ground, and thus, the valve needs to be installed in the ground in a state of being inclined. However, the height-adjustable valve for continuous water supply according to the present invention provides a structural configuration capable of solving the above-described problem.

### DESCRIPTION OF DRAWINGS

The above and other objects, features and other advantages of the present invention will be more clearly understood from the following detailed description taken in conjunction with the accompanying drawings, in which:

FIG. 1 is a diagram showing a bonnet accommodating a valve disc of a height-adjustable valve for continuous water supply according to the present invention, in which the diagram shows a non-inserted state in which a low-height insert body is not inserted into the bonnet and an inserted state in which the low-height insert body is inserted into the bonnet;

FIG. 2 is a diagram showing an installation example of the height-adjustable valve for continuous water supply according to the present invention, in which the diagram shows the non-inserted state in which the low-height insert body is not inserted into the bonnet and the inserted state in which the low-height insert body is inserted into the bonnet;

FIG. 3 is an exploded view of the valve disc of the height-adjustable valve for continuous water supply according to the present invention;

FIGS. 4 and 5 are diagrams each showing a conventional height-adjustable valve for continuous water supply;

FIGS. 6 to 13 are diagrams each showing a construction sequence of the height-adjustable valve for continuous water supply according to the present invention;

FIG. 14 is a diagram showing a height-adjustable valve for continuous water supply according to another embodiment of the present invention;

FIG. 15 is a diagram showing an external configuration of the height-adjustable valve for continuous water supply shown in FIG. 14, in which the diagram shows the respective external configurations in a non-inserted state in which a height adjustment bonnet is not inserted into a fixed bonnet and an inserted state in which the height adjustment bonnet is inserted into the fixed bonnet;

FIG. 16 is a diagram showing an internal configuration of the height-adjustable valve for continuous water supply shown in FIG. 14, in which the diagram shows the respective internal configurations in the non-inserted state in which the height adjustment bonnet is not inserted into the fixed bonnet and the inserted state in which the height adjustment bonnet is inserted into the fixed bonnet;

FIG. 17 is a diagram showing a height-adjustable valve for continuous water supply according to still another embodiment of the present invention;

FIG. 18 is a diagram showing an external configuration of the height-adjustable valve for continuous water supply shown in FIG. 17, in which the diagram shows the respective external configurations in a non-inserted state in which a height adjustment bonnet is not inserted into a fixed bonnet and an inserted state in which the height adjustment bonnet is inserted into the fixed bonnet; and

FIG. 19 is a diagram showing an internal configuration of the height-adjustable valve for continuous water supply shown in FIG. 17, in which the diagram shows the respective internal configurations in the non-inserted state in which the height adjustment bonnet is not inserted into the fixed bonnet and the inserted state in which the height adjustment bonnet is inserted into the fixed bonnet.

### BEST MODE

Terms or words used in the description and claims should not be restrictively interpreted as having ordinary or dictionary meanings, but should be interpreted as having meanings and concepts conforming to the inventive concept on the basis of the principle that an inventor may properly define the concept of a term to explain his or her own invention in the best way.

Therefore, embodiments described in this specification and configurations shown in the drawings are only preferred embodiments of the present invention and do not represent the entire technical idea of the present invention. It should be understood that those skilled in the art will appreciate that various modifications, additions, and substitutions are possible, without departing from the scope and spirit of the invention as disclosed in the accompanying claims.

In describing the embodiments disclosed herein, when it is determined that a detailed description of publicly known techniques to which the disclosure pertains may obscure the gist of the present disclosure, detailed description thereof will be omitted.

The present invention relates to a height-adjustable valve for continuous water supply.

More specifically, the present invention relates to a valve for continuous water supply having a structure capable of adjusting the height of a bonnet configured to accommodate a valve disc therein. In the related art, during construction of the valve for continuous water supply, when the depth of a pipe is close to the ground, a partial structure of the valve protrudes outwards from the ground. In this case, the valve needs to be installed in the ground in a state of being inclined. In order to address such an inconvenience, the present invention provides a height-adjustable valve for continuous water supply capable of further lowering the height of a bonnet configured to accommodate a valve disc therein as compared with a bonnet of the related art.

Hereinafter, the height-adjustable valve for continuous water supply according to the present invention will be described with reference to the accompanying drawings.

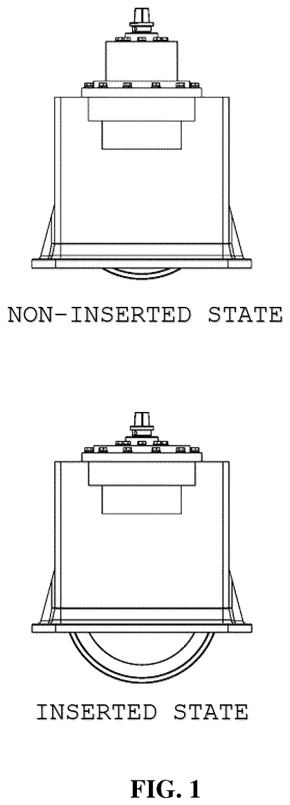

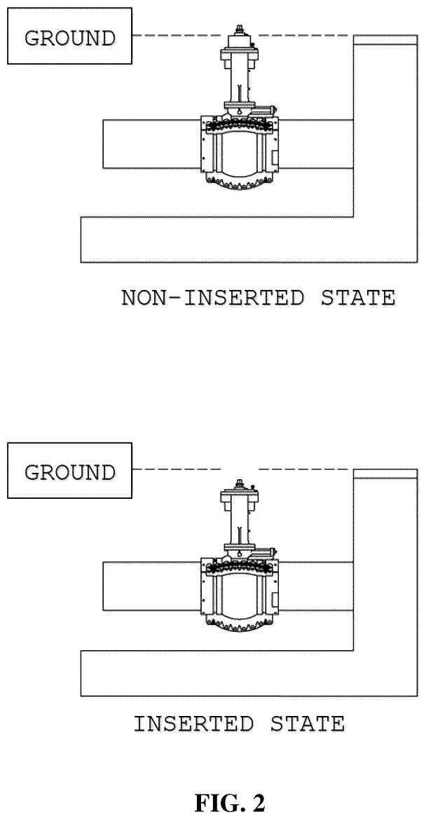

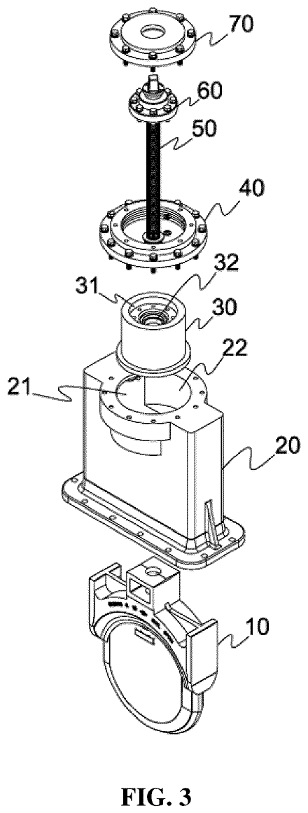

FIG. 1 is a diagram showing a bonnet accommodating a valve disc of a height-adjustable valve for continuous water supply according to the present invention, in which the diagram shows a non-inserted state in which a low-height insert body is not inserted into the bonnet and an inserted state in which the low-height insert body is inserted into the bonnet, FIG. 2 is a diagram showing an installation example of the height-adjustable valve for continuous water supply according to the present invention, in which the diagram shows the non-inserted state in which the low-height insert body is not inserted into the bonnet and the inserted state in which the low-height insert body is inserted into the bonnet, FIG. 3 is an exploded view of the valve disc of the height-adjustable valve for continuous water supply according to the present invention

The height-adjustable valve for continuous water supply according to the present invention includes all the structural configurations of the conventional valve for continuous water supply. Here, only a bonnet configured to accommodate a valve disc therein is modified in the height-adjustable valve for continuous water supply according to the present invention.

All the structural configurations of the valve for continuous water supply are described in the present applicant's Korean patent No. 10-1906108 (entitled “METHOD OF FORMING PERFORATION IN PIPELINE THROUGH EFFICIENT ROTARY PERFORATION”).

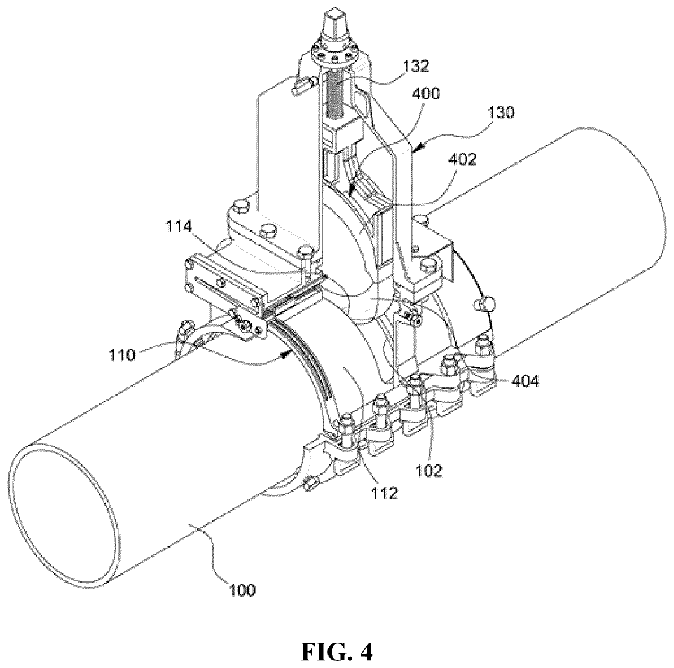

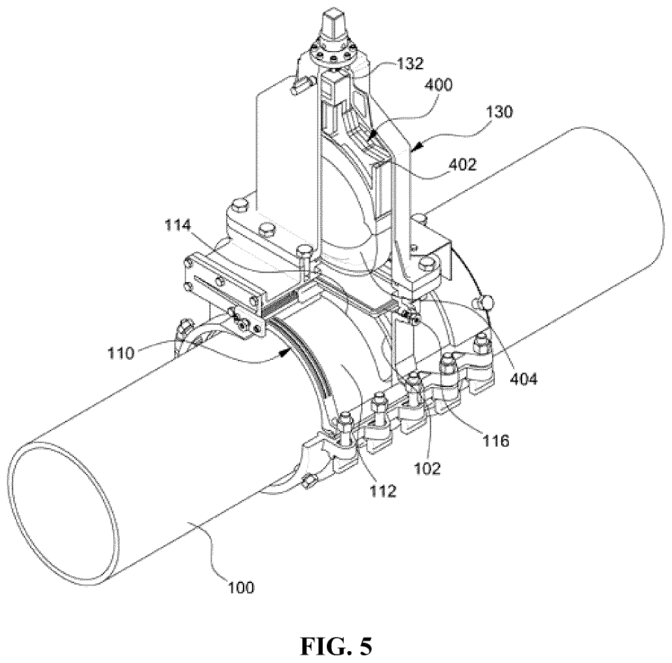

As shown in FIGS. 3 and 4, a bonnet structure of the height-adjustable valve for continuous water supply according to the present invention includes a valve disc 10, a bonnet 20 configured to accommodate the valve disc 10 therein and coupled to a housing so as to withdraw the valve disc 10, a low-height insert body 30 inserted into the upper side of the bonnet 20 and configured to adjust a height of the bonnet, an intermediate cover 40 configured to cover the upper side of the bonnet 20 having the low-height insert body 30 inserted thereinto, the intermediate cover having a hole formed in one side thereof, the hole having a predetermined diameter, a stem cover 60 inserted into and seated in the low-height insert body 30, a stem 50 coupled to one side of the stem cover 60, the stem penetrating the intermediate cover 40, the low-height insert body 30, and the bonnet 20 in the downward direction so as to be coupled to the valve disc 10, and a fixing cover 70 coupled to the upper side of the intermediate cover 40 and configured to cover a lower portion of the stem cover 60, the fixing cover having a hole formed in one side thereof, the hole being configured for one end of the stem to be exposed therethrough.

In addition, the bonnet 20 has an upper surface, one side of which is expanded in a circular shape. The upper surface has a hole 21 formed in the other side thereof, the hole having a diameter at least larger than a diameter of the low-height insert body 30 such that the low-height insert body is inserted into the bonnet through the hole.

In addition, the bonnet 20 further includes a seating part 22 provided in the hole 21, the seating part being configured for the low-height insert body 30 to be seated thereon in a state of being inserted into the hole 21.

In this case, the seating part 22 is configured to be integrally coupled to the inner side of the expanded upper surface of the bonnet 20 by erecting a side wall including a semicircular plate.

Here, since the lower surface of the seating part 22 is formed to have the semicircular shape, it is possible not only to enable the stem 50 that has penetrated the seated low-height insert body 30 to be further moved in the downward direction so as to be coupled to the valve disc 10, but also to prevent interference with movement of the valve disc 10.

In this case, at least two semicircular plates are provided such that the low-height insert body 30 is stably seated thereon.

In addition, the low-height insert body 30 includes a through hole 32 formed to penetrate the inner side thereof in the height direction of the low-height insert body. Further, the low-height insert body 30 has a concave seating groove 31 formed in one side of the upper surface thereof.

The stem cover 60 is seated in the seating groove 31 and is coupled to the low-height insert body with a bolt and the like.

A detailed description will be given below as to the above-described structure. A lower portion of the low-height insert body 30 is configured to be bent and expanded, and the hole 21 of the bonnet 20 is formed to have a diameter corresponding to a diameter of the expanded lower portion of the low-height insert body 30.

A diameter of the through hole of the intermediate cover 40 is formed to correspond to a diameter of the non-expanded area of the low-height insert body 30.

In addition, a plurality of grooves is formed in the circumferential direction on the inner wall surface of a through hole of the intermediate cover 40, and O-rings arranged in two rows are respectively coupled to the plurality of grooves, thereby improving airtightness between the intermediate cover 40 and the low-height insert body 30. Accordingly, it is possible to improve watertightness therebetween.

In this structural configuration, when the intermediate cover 40 is coupled to the bonnet 20, the low-height insert body 30 is fixed by the intermediate cover 40 in a state in which the expanded end of the low-height insert body is located in the hole 21 of the bonnet 20.

Thereafter, the low-height insert body 30 is pressed downwards so as to be inserted into the bonnet at the construction site. In this manner, an upper portion of the valve may be prevented from being exposed to the ground, as shown in FIG. 2.

Therefore, since it is not necessary to perform tilting work for the valve, work efficiency may be improved.

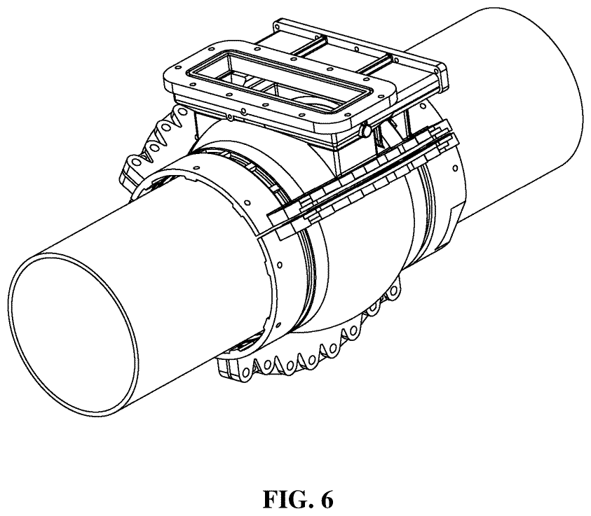

A description will be given as to a construction example of the valve for continuous water supply according to the present invention, which is capable of adjusting the height thereof, with reference to FIG. 6 and the subsequent drawings.

First, as shown in FIG. 6, the upper and lower plates of the valve for continuous water supply are installed on a pipe as in the related art.

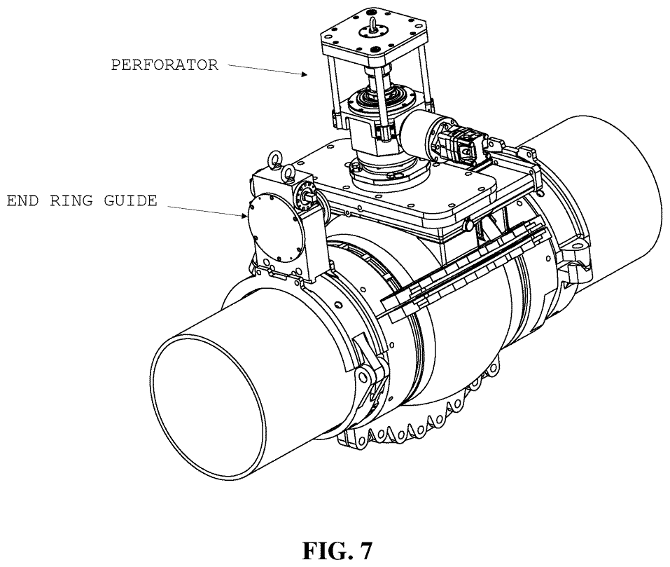

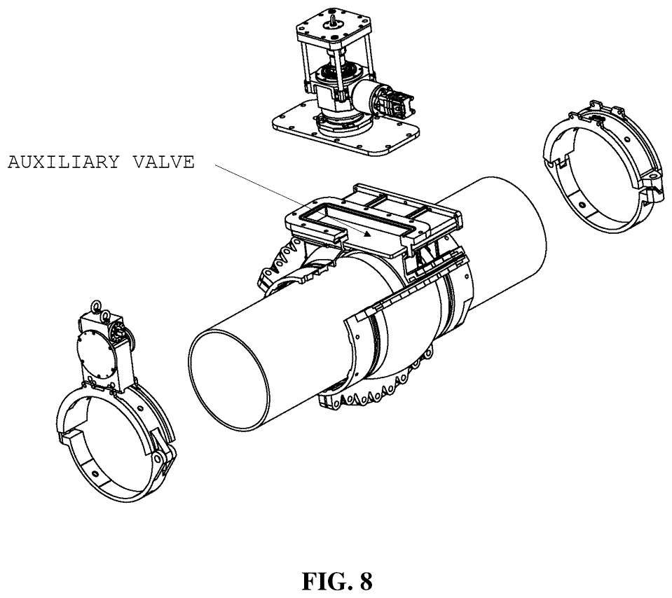

Next, as shown in FIG. 7, a perforator and an end ring guide are installed on the valve for continuous water supply so as to perform perforation work on the pipe. Thereafter, as shown in FIG. 8, an auxiliary valve is closed after perforation work is completed, and the end ring guide and the perforator are separated from the pipe.

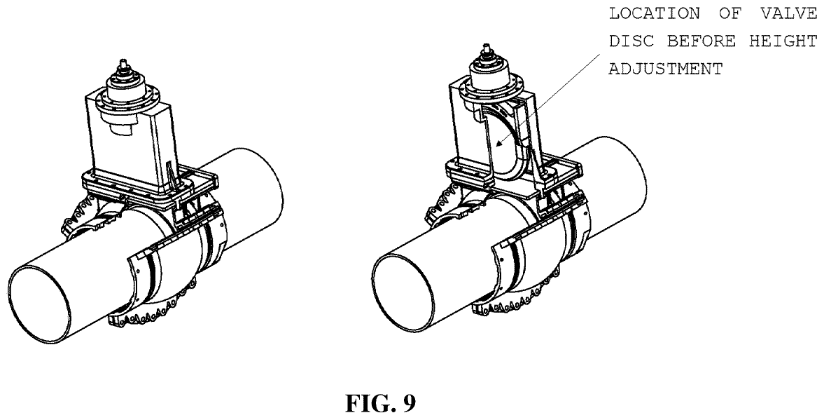

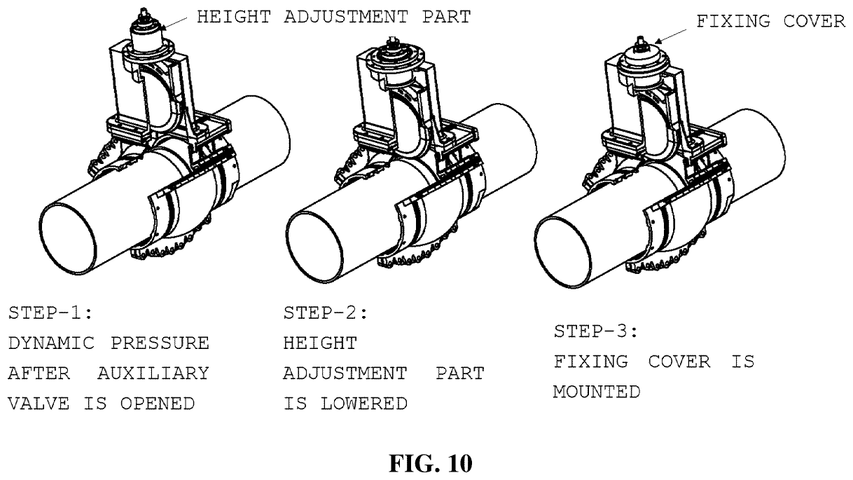

Then, a height-adjustable bonnet according to the present invention is installed in a housing (the upper plate and the lower plate), as shown in FIG. 9. Thereafter, the auxiliary valve is opened, the bonnet is adjusted in consideration of the flow of water, the low-height insert body 30 is pressed to be moved downwards, and the fixing cover 70 is coupled and fixed to the bonnet (FIG. 10).

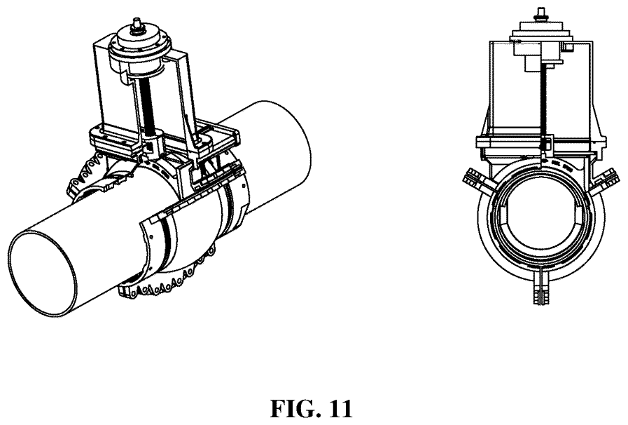

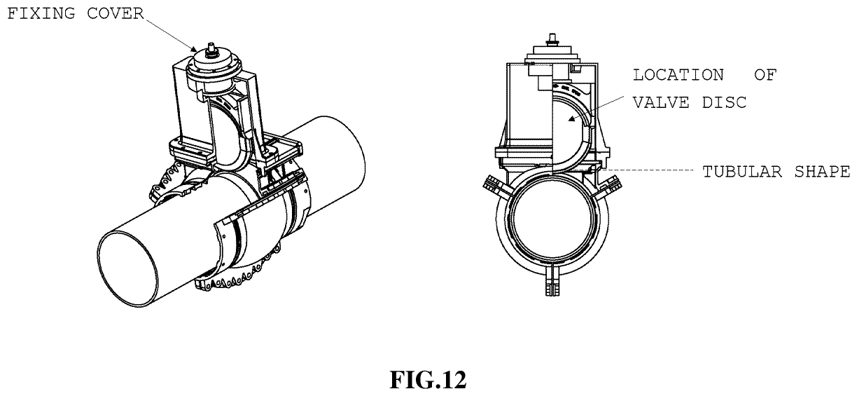

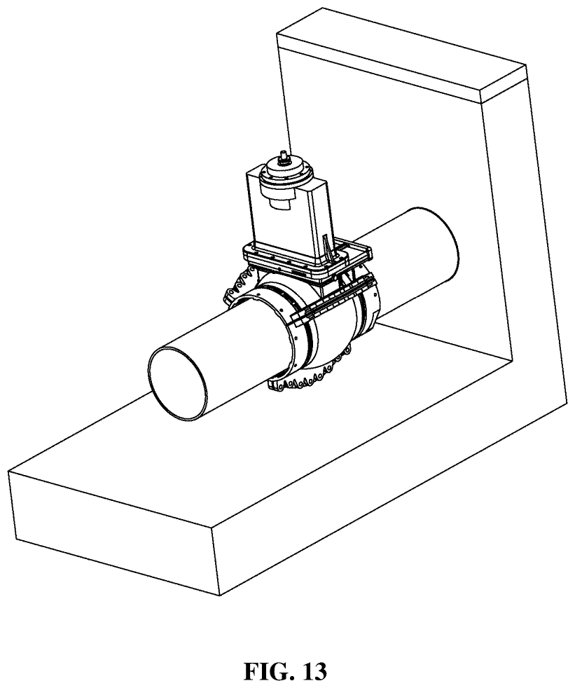

Next, as shown in FIG. 11, after the fixing cover is coupled to the bonnet, the valve disc 10 is moved downwards so as to perform construction of a continuous water supply. Then, as shown in FIGS. 12 and 13, after construction is completed, the valve disc 10 is moved upwards.

Meanwhile, according to another embodiment, in order to achieve the height-adjustable valve for continuous water supply according to the present invention, the height of the bonnet may be designed to be adjustable.

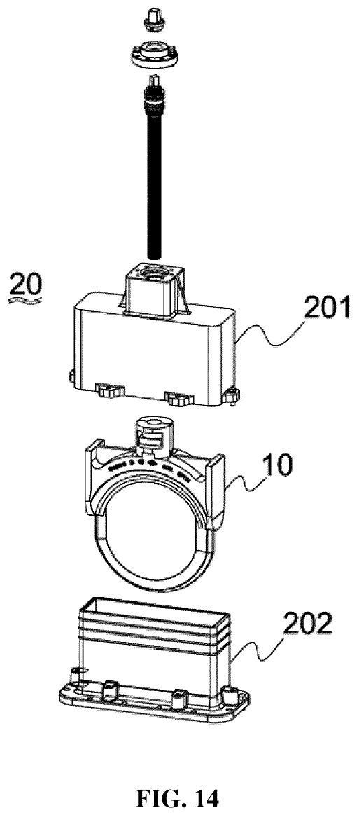

As described above, height adjustment may be achieved by inserting the low-height insert body 30 into the bonnet. Alternatively, as described below with reference to FIGS. 14 to 19, height adjustment may be achieved by adjusting the height of the bonnet 20.

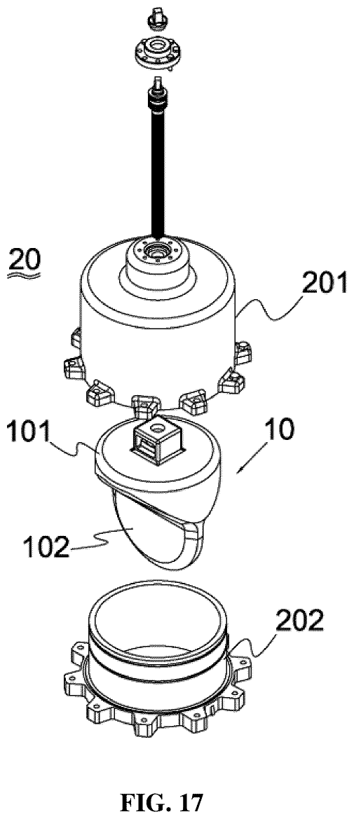

First, FIGS. 14 to 16 are diagrams each showing a square-shaped bonnet according to the embodiment. In addition, FIGS. 17 to 19 are diagrams each showing a cylindrical bonnet according to the embodiment.

However, the shape of the bonnet is not limited to a square shape or a cylindrical shape. The bonnet may be formed to have various shapes as long as the same has a configuration within the scope of the present invention.

FIG. 14 is a diagram showing a height-adjustable valve for continuous water supply according to another embodiment of the present invention.

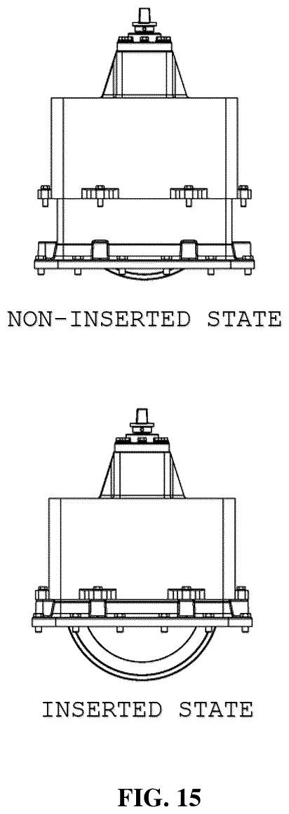

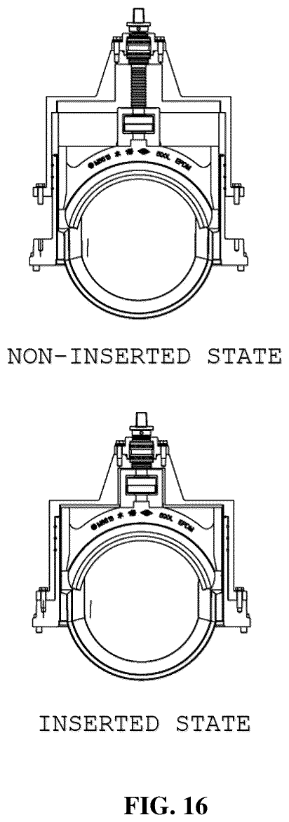

In addition, FIG. 15 is a diagram showing an external configuration of the height-adjustable valve for continuous water supply shown in FIG. 14, in which the diagram shows the respective external configurations in a non-inserted state in which a height-adjustable bonnet is not inserted into a fixed bonnet and an inserted state in which the height-adjustable bonnet is inserted into the fixed bonnet, and FIG. 16 is a diagram showing an internal configuration of the height-adjustable valve for continuous water supply shown in FIG. 14, in which the diagram shows the respective internal configurations in the non-inserted state in which the height-adjustable bonnet is not inserted into the fixed bonnet and the inserted state in which the height-adjustable bonnet is inserted into the fixed bonnet.

The bonnet according to the embodiment is configured by being cut in the form of an antenna, and one of the bonnets is a fixed bonnet 202 that forms the lower side of the bonnet and is fixedly connected to a housing, and the other one is a height-adjustable bonnet 201 having a size and shape inserted into the exterior side of the fixed bonnet 202, in which the height-adjustable bonnet has a bolt coupling structure disposed on one side thereof and configured to be bolted to the fixed bonnet 202.

In this case, the fixed bonnet 202 includes a number of sealing members (O-rings, packing members, and the like) provided on the outer surface thereof. Here, pressing force is applied to the height-adjustable bonnet 201 toward the fixed bonnet 202 and is pushed and inserted into the fixed bonnet 202. Accordingly, the bonnet according to another embodiment may achieve the desired height thereof in such a manner that the height-adjustable bonnet serving as an upper bonnet is inserted into the fixed bonnet serving as a lower bonnet.

Thereafter, the fixed bonnet 202 and the height-adjustable bonnet 201 are coupled to each other using bolts.

The above-described bonnet may be formed to have a square shape as described above. Alternatively, this bonnet may be formed to have a cylindrical shape, as shown in FIG. 17.

FIG. 17 is a diagram showing a height-adjustable valve for continuous water supply according to still another embodiment of the present invention.

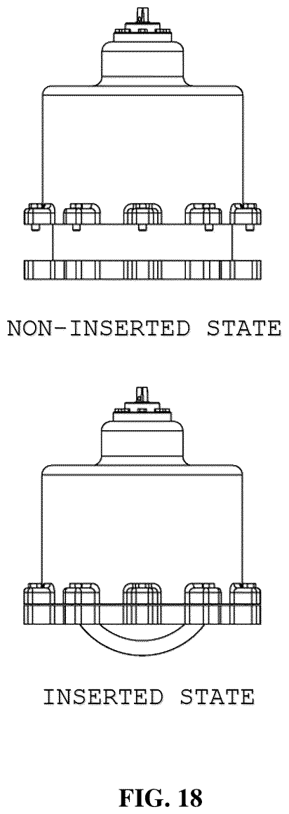

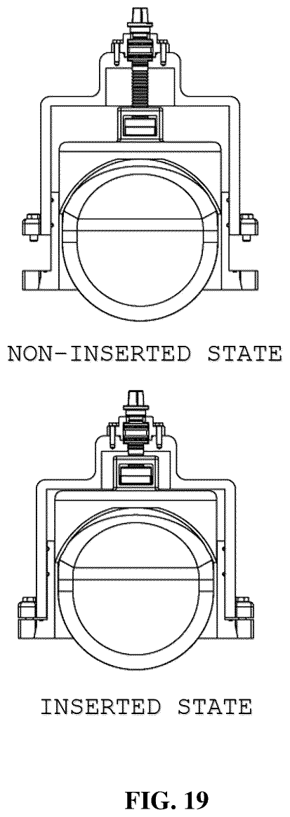

In addition, FIG. 18 is a diagram showing an external configuration of the height-adjustable valve for continuous water supply shown in FIG. 17, in which the diagram shows the respective external configurations in a non-inserted state in which a height-adjustable bonnet is not inserted into a fixed bonnet and an inserted state in which the height-adjustable bonnet is inserted into the fixed bonnet, and FIG. 19 is a diagram showing an internal configuration of the height-adjustable valve for continuous water supply shown in FIG. 17, in which the diagram shows the respective internal configurations in the non-inserted state in which the height-adjustable bonnet is not inserted into the fixed bonnet and the inserted state in which the height-adjustable bonnet is inserted into the fixed bonnet.

However, in the case of the embodiment in which the bonnet has a cylindrical shape, the shape of the valve disc 10 may be slightly changed. For example, the upper valve disc 101 may be formed to have a cylindrical shape on the lower side of an area to which the stem 50 is coupled, and both side surfaces of the cylindrical shape may be inclined downwards and may converge at one point. Here, a lower valve disc 102 may be configured to be integrally extended from one side of the lower side so as to perform the role of a conventional valve disc.

Although embodiments of the present invention have been described above with reference to the accompanying drawings, the present invention is not limited to the configurations shown in the drawings, and those skilled in the art will appreciate that various modifications, additions, and substitutions are possible, without departing from the scope and spirit of the invention as disclosed in the accompanying claims.

1. A height-adjustable valve for continuous water supply, the height-adjustable valve comprising a bonnet structure having an adjustable height,
wherein the height of the bonnet structure is lowered by pressing force applied to the bonnet structure at a construction site, and the bonnet structure maintains the lowered height thereof.

2. The height-adjustable valve according to claim 1, wherein the bonnet structure maintains the lowered height thereof by pressing a low-height insert body (30) into the bonnet structure and coupling a fixing cover (70) to the bonnet structure at the construction site.

3. The height-adjustable valve according to claim 2, wherein the bonnet structure comprises:
a valve disc (10);
a bonnet (20) configured to accommodate the valve disc (10) therein, the bonnet being coupled to a housing so as to withdraw the valve disc (10);
the low-height insert body (30) inserted into an upper side of the bonnet (20), the low-height insert body being configured to adjust a height of the bonnet;
an intermediate cover (40) configured to cover the upper side of the bonnet (20) having the low-height insert body (30) inserted thereinto, the intermediate cover having a hole formed in one side thereof, the hole having a predetermined diameter;
a stem cover (60) inserted into and seated in the low-height insert body (30);
a stem (50) coupled to one side of the stem cover (60), the stem penetrating the intermediate cover (40), the low-height insert body (30), and the bonnet (20) in a downward direction so as to be coupled to the valve disc (10); and
the fixing cover (70) coupled to an upper side of the intermediate cover (40) and configured to cover a lower portion of the stem cover (60), the fixing cover having a hole formed in one side thereof, the hole being configured for one end of the stem to be exposed therethrough.

4. The height-adjustable valve according to claim 3, wherein:
the low-height insert body (30) has a lower end formed to be bent and expanded,
the low-height insert body (30) comprises a through hole (32) formed to penetrate an inner side thereof in a height direction of the low-height insert body (30), and
the low-height insert body (30) has a concave seating groove (31) formed in one side of an upper surface thereof.

5. The height-adjustable valve according to claim 4, wherein:
one side of an upper surface of the bonnet (20) is formed to be expanded in a circular shape, and
the upper surface has a hole (21) formed in the other side thereof, the hole being formed to have a diameter corresponding to an expanded area of the low-height insert body (30).

6. The height-adjustable valve according to claim 5, wherein:
the bonnet (20) further comprises a seating part (22) provided in the hole (21) of the bonnet (20), the seating part being configured for the low-height insert body (30) to be seated thereon in a state of being inserted into the hole, and
the seating part (22) comprises a semicircular plate configured to, when the stem (50) penetrating the low-height insert body (30) is further moved in the downward direction so as to be coupled to the valve disc (10), prevent interference with movement of the stem (50), and a side wall is erected from the semicircular plate and is integrally coupled to an inner side of the expanded upper surface of the bonnet (20).

7. The height-adjustable valve according to claim 3, wherein:
the intermediate cover (40) comprises a through hole formed in one side thereof, and
the through hole of the intermediate cover (40) has a diameter corresponding to an unexpanded diameter of the low-height insert body (30).

8. The height-adjustable valve according to claim 7, wherein an O-ring is located between the through hole of the intermediate cover (40) and the low-height insert body (30).

9. The height-adjustable valve according to claim 2, wherein, when the intermediate cover (40) is coupled to the bonnet (20), the expanded end of the low-height insert body (30) is located in the hole (21) of the bonnet (20) in a state in which the low-height insert body is fixed by the intermediate cover (40), and then, the low-height insert body (30) is pressed downwards so as to be inserted into the bonnet at the construction site, thereby preventing the end of the stem from being exposed to an upper side of the ground during construction.

10. The height-adjustable valve according to claim 1, wherein:
the bonnet (20) is formed of a height-adjustable bonnet (201) disposed at an upper portion of the bonnet and a fixed bonnet (202) disposed at a lower portion thereof so as to adjust a height of the bonnet in a form of an antenna, and
the height-adjustable bonnet (201) is inserted into the fixed bonnet (202) so as to adjust the height of the bonnet.

11. The height-adjustable valve according to claim 10, further comprising a bolt fixing structure configured to, after the height-adjustable bonnet (201) is inserted into the fixed bonnet (202), fix the height-adjustable bonnet to the fixed bonnet using a bolt.

12. The height-adjustable valve according to claim 11, wherein the fixed bonnet (202) has a plurality of sealing means provided on one side thereof, the sealing means being configured to seal a space between the fixed bonnet and the height-adjustable bonnet (201).

13. The height-adjustable valve according to claim 10, wherein the fixed bonnet (202) has any one shape selected from a square, a cylinder, and a polygon.
